(19) United States
(12) Patent Application Publication
(10) Pub. No.: US 2005/0142899 A1
(43) Pub. Date: Jun. 30, 2005

(54) Rotating connection

(76) Inventors: Heinz Billing, Haunetal/Wehrda (DE); Erich Beer, Huenfeld (DE)

Correspondence Address: Striker Striker & Stenby, 103 East Neck Road, Huntington, NY, 11743, US

(21) Appl. No.: 10/507,998

(22) PCT Filed: Apr. 12, 2003
(86) PCT No.: PCT/EP03/03812

(30) Foreign Application Priority Data
Apr. 26, 2002 (DE) 102 18 694.4

(51) Int. Cl. H01R 39/00

(52) U.S. Cl. 439/13

(57) ABSTRACT

An electrical swivel coupling (1) with one inner and one outer wiper contact ring arrangement (2, 3) for transmitting electric currents; the inner wiper contact ring arrangement (2) is provided with a plurality of first wiper rings (4), which have first lugs (7) leading on one side outward in the direction (6) of the axis, and each first wiper ring (4) with a first lug (7) is of one-piece construction. The outer wiper contact ring arrangement (3) is provided with a plurality of second wiper rings (5), which have second lugs (8) leading on one side outward in an opposite direction (9) of the axis, and each second wiper ring (5) with a second lug (8) is of one-piece construction. The second wiper rings (5) are provided with a plurality of spring contacts (10), which are formed by material recessing and deformation. The spring contacts (10) of the second wiper rings (5) are each in electrical contact with an outer wiper ring surface (18) of the first wiper rings (4) (FIG. 4).

The invention relates to a coupling as generically defined by the preamble to claim 1.

Electrical swivel joint couplings are known, for instance for installation in bearings for carrier elements from which electrically driven appliances are suspended. In these couplings, the current of the axially successive contact rings in the rotor is carried to the outside with the aid of solidly-soldered connection cables. These contact rings are tapped by metal bands with cut-in, outward-curved contact ribs, as known for instance from German Patent Disclosure DE 39 18 234 A1.

The object of the invention is to create a coupling of this generic type which is simpler and more compact in construction and less expensive to produce yet has very good electrical properties.

This object is attained in accordance with the characteristics of the body of claim 1. Further features of the invention will become apparent from the dependent claims. The subject of the invention is a swivel coupling for transmitting electrical currents with full through-rotatability of the swivel coupling and with an integrated plug connection for undoing an electrical connection; economical production is made possible by a simple structural design. The plug coupling comprises a rotor and a stator, with for instance up to five current paths of equal rank, with which both signal currents and power currents can be transmitted.

The invention will be described in further detail in conjunction with a plurality of drawings.

Shown are:

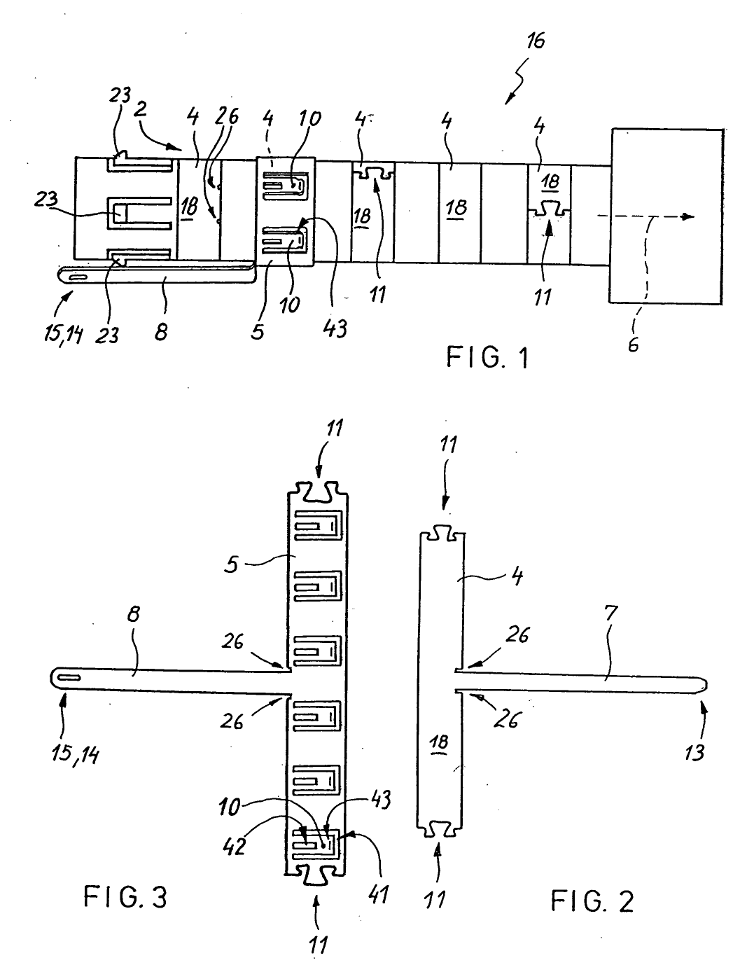

FIG. 1, in a side view, a rotor with a plurality of first wiper rings, as part of a swivel coupling, and with an axially slipped-on second wiper ring;

FIG. 2, a developed view of a first wiper ring;

FIG. 3, a developed view of a second wiper ring;

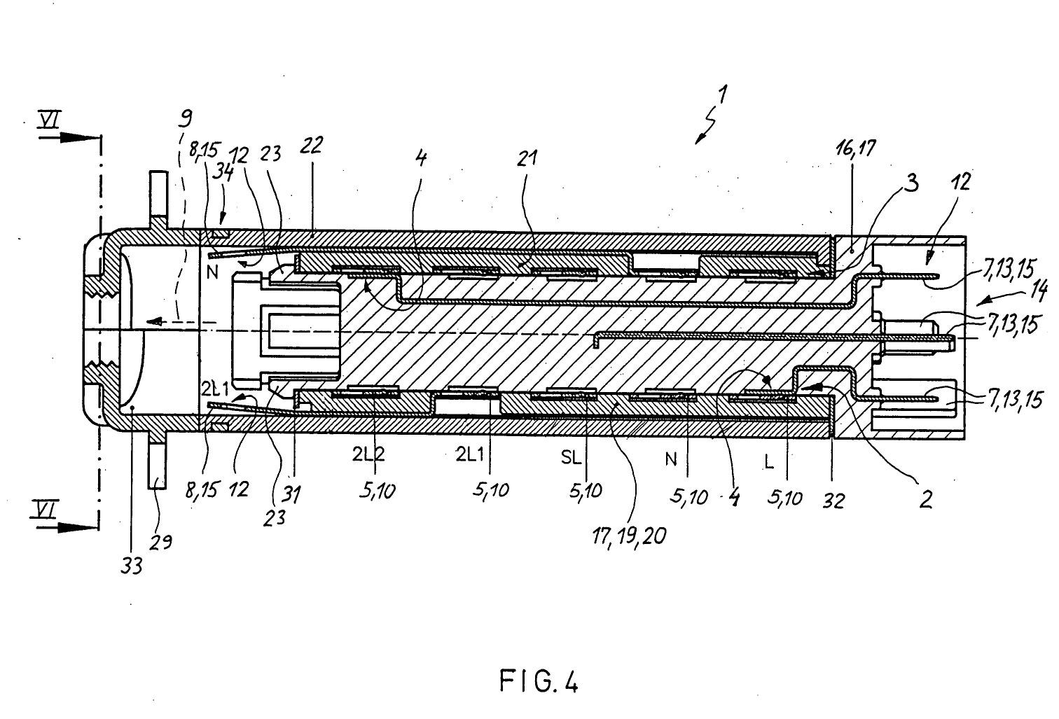

FIG. 4, in an axial section, the complete swivel coupling;

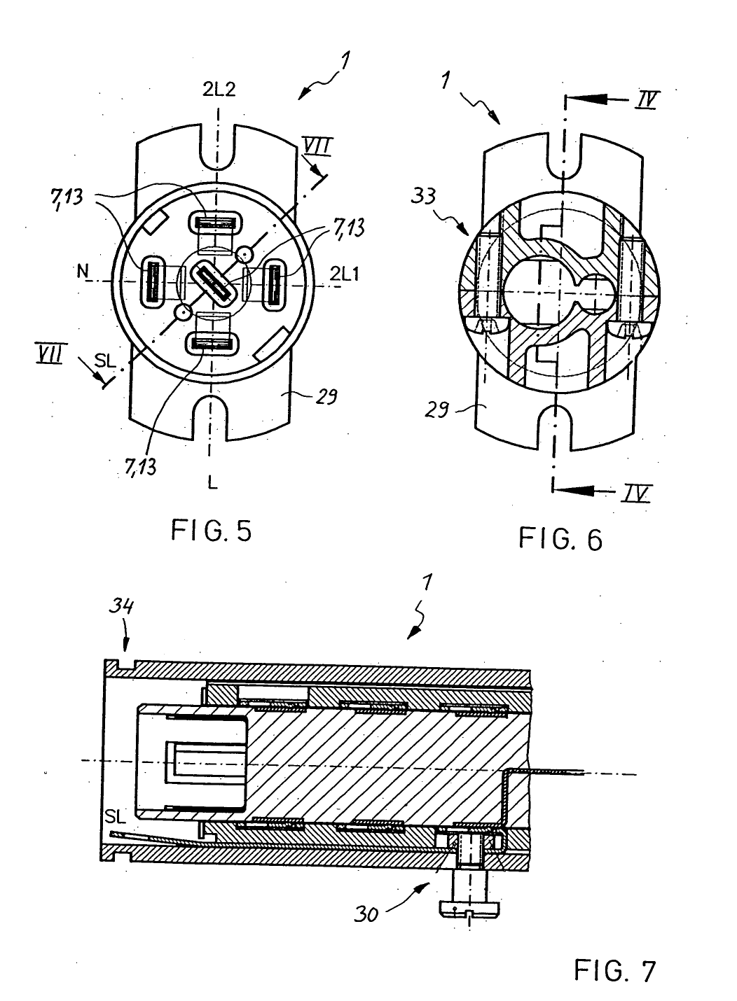

FIG. 5, in an axial section, a plug connection;

FIG. 6, a section taken along the line VI-VI of FIG. 4;

FIG. 7, a section taken along the line VII-VII of FIG.

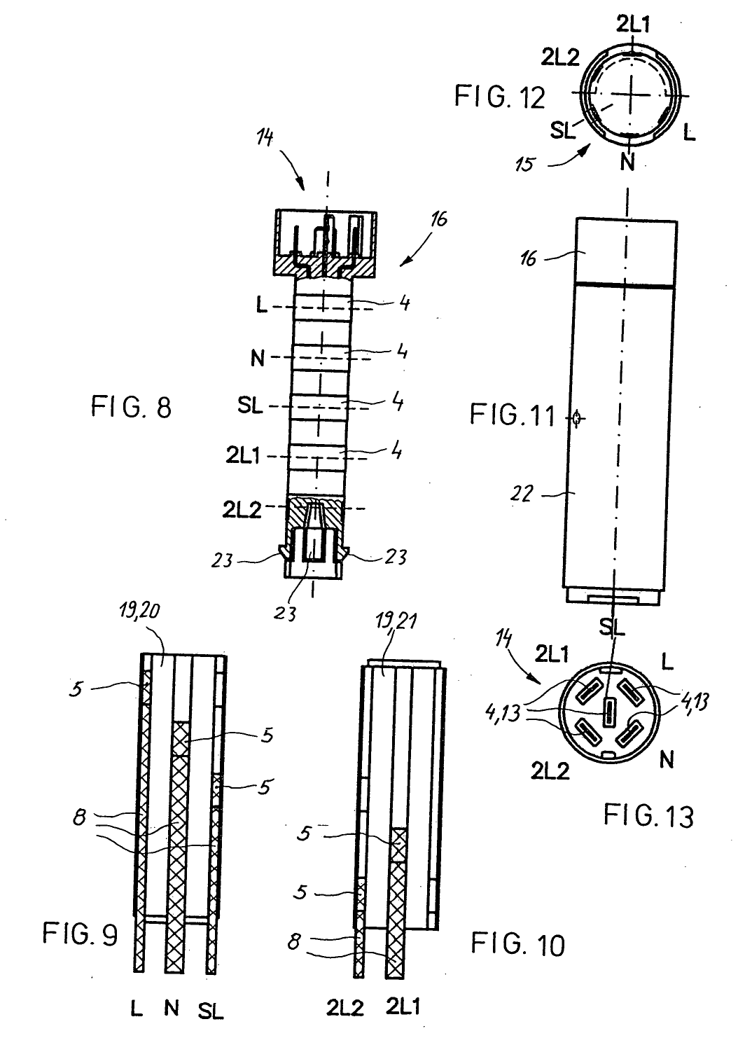

FIG. 8, in a plan view, the rotor with fragmentary sections;

FIG. 9, in a side view, a first half-shell with second wiper rings and second lugs;

FIG. 10, in a side view, a second half-shell with second wiper rings and second lugs;

FIG. 11, in a side view, the swivel coupling;

FIG. 12, in an axial view, the soldered connection;

FIG. 13, in an axial view, the plug connection;

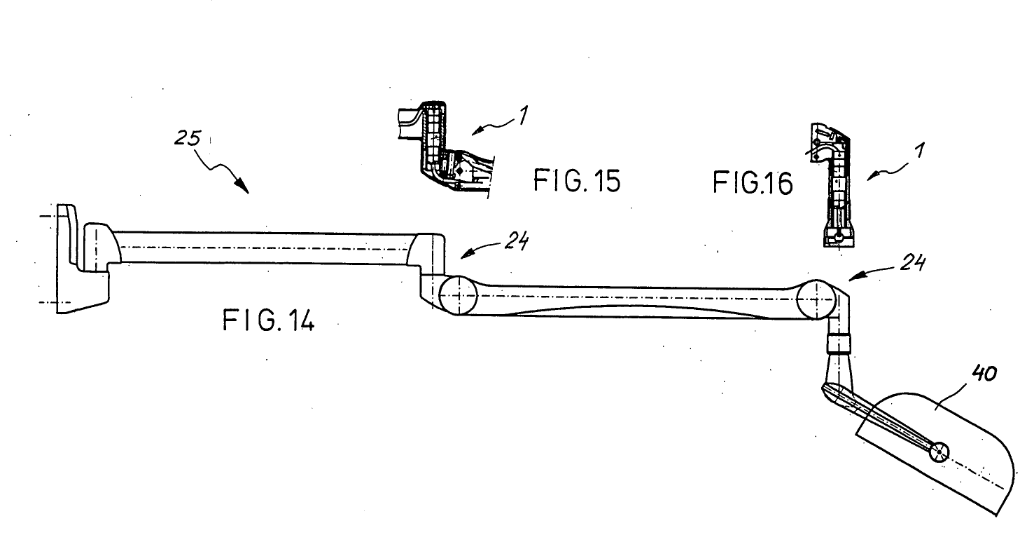

FIG. 14, in a side view, a tripod with built-in swivel couplings;

FIG. 15, in a fragmentary sectional view, a first swivel coupling;

FIG. 16, in a fragmentary sectional view, a second swivel coupling;

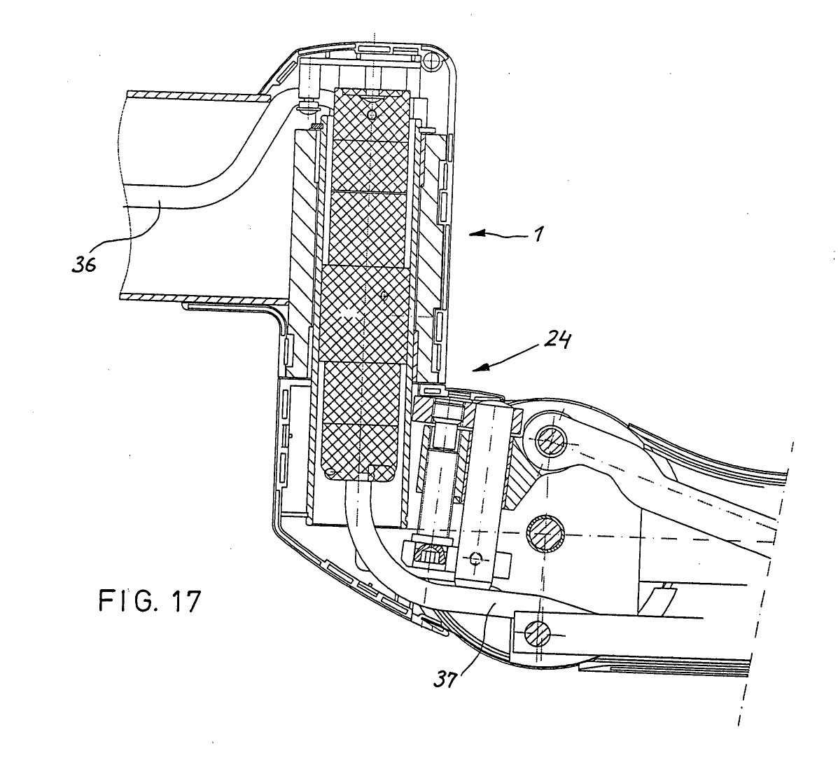

FIG. 17, in an enlarged view, the first swivel coupling of FIG. 15;

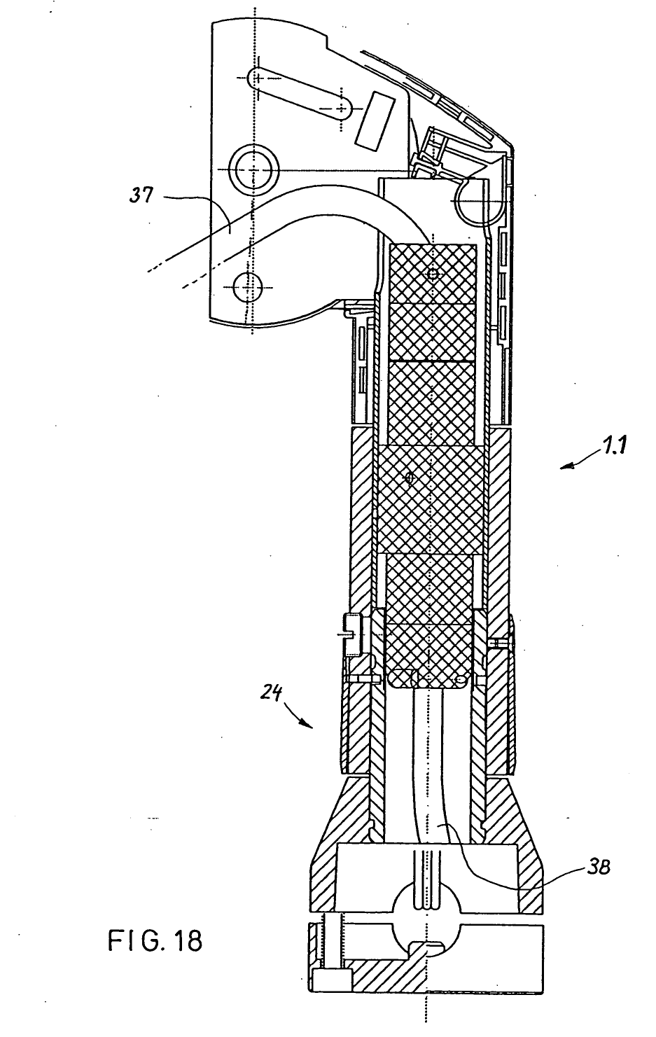

FIG. 18, in an enlarged view, the second swivel coupling of FIG. 16;

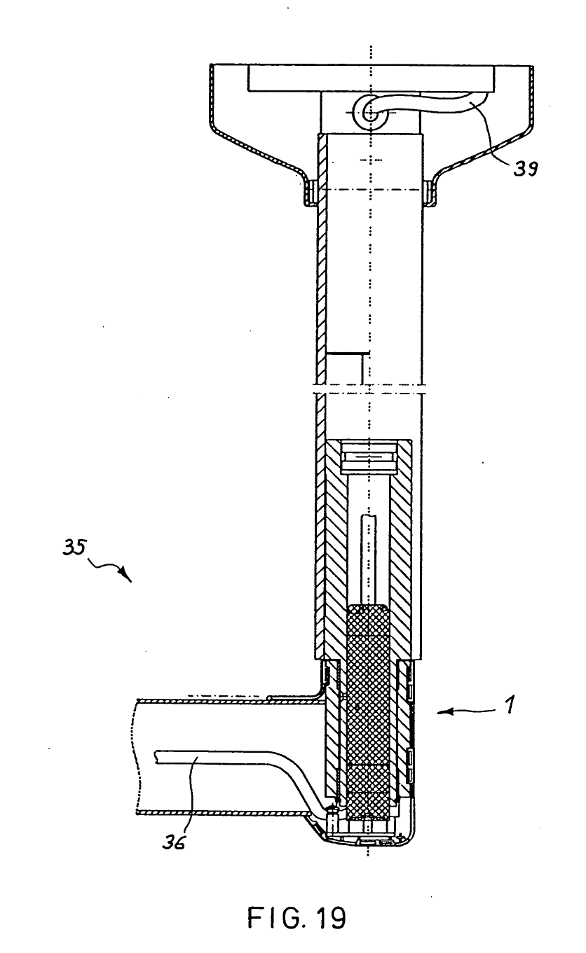

FIG. 19, in a sectional side view, a support for a ceiling mounting;

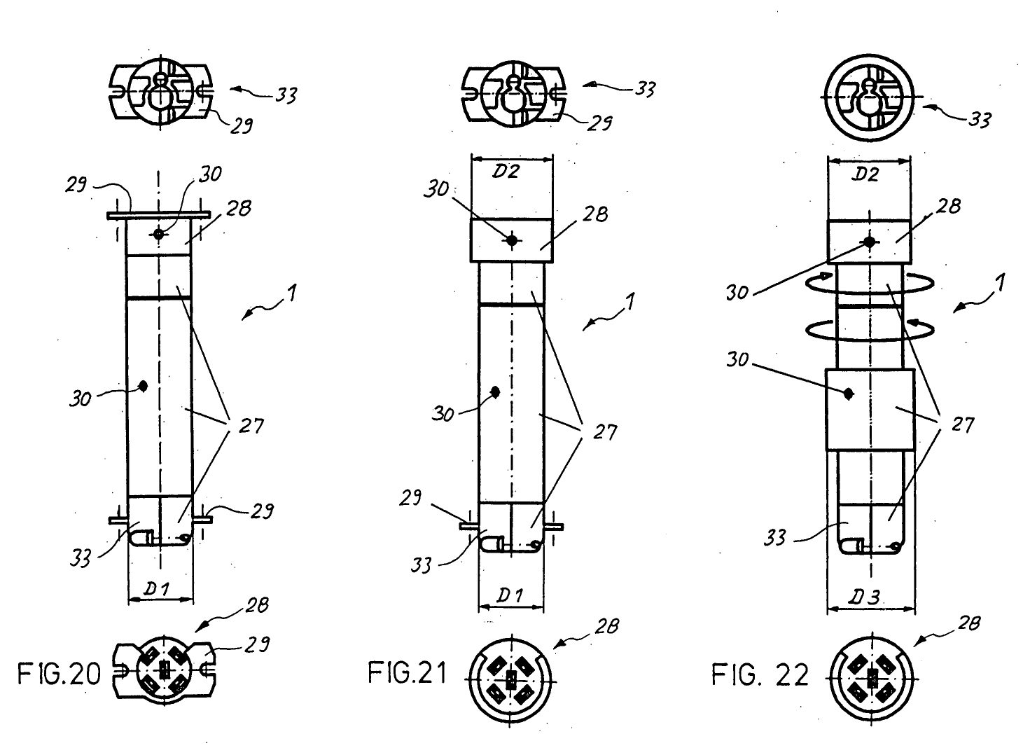

FIG. 20, in various views, a first variant of a swivel coupling;

FIG. 21, in various views, a second variant of a swivel coupling; and

FIG. 22, in various views, a third variant of a swivel coupling.

The drawings show an electrical swivel coupling 1 with one inner and one outer wiper contact ring arrangement 2, 3 for transmitting electric currents, wherein the inner wiper contact ring arrangement 2 is provided with a plurality of first wiper rings 4, which have first lugs 7 leading on one side outward in the direction 6 of the axis, and each first wiper ring 4 with a first lug 7 is of one-piece construction. The outer wiper contact ring arrangement 3 is provided with a plurality of second wiper rings 5, which have second lugs 8 leading on one side outward in an opposite direction 9 of the axis, and each second wiper ring 5 with a second lug 8 is of one-piece construction. The second wiper rings 5 are provided with a plurality of spring contacts 10, which are formed by material recessing and deformation. The spring contacts 10 of the second wiper rings 5 are each coaxially in electrical contact with an outer wiper ring surface 18 of the first wiper rings 4. The result is a simple, compact structure of the coupling 1 as well as very good electrical conductivity, since the electrical transition points (contact and soldering points) are limited to a minimum.

In FIG. 2, in a developed view, the first wiper ring 4, with a first lug 7 as an electrical conductor, is shown and is in the shape of a T. The end of the first lug 7 is designed as a contact tongue 13. Depending on the axial arrangement of the first wiper rings 4 on the rotor 16, a certain length of the first lug 7 is required so that the contact tongues 13 will come to an end for a plug connection 14 in the same plane. For bending over the first lug 7, small notches 26 are provided. The first wiper rings 4 are formed by a positive-engagement groove connection 11, and in particular by a dovetail or tongue-and-groove connection created by bending it over into a ring 4.

In FIG. 3, in a developed view, the second wiper ring 5, with a second lug 8 as an electrical conductor, is shown and is in the shape of a T. The second wiper ring 5 is provided with a plurality of identically disposed spring contacts 10. The spring contacts 10 are formed by a U-shaped recess 41, a weakening recess 42, and a deformation 43, respectively. The end of the second lug 8 is embodied for a soldered connection 15. A plug connection 14 may selectively be provided as well. Depending on the axial arrangement of the second wiper rings 5, a certain length of the second lug 8 is necessary, so that the soldered connections 15 will come to an end in the same plane. For bending over the second lug 8, small notches 26 are provided. The second wiper rings 5 are formed by a positive-engagement groove connection 11, and in particular by a dovetail or tongue and groove connection that results by bending it over into a ring 5. Selectively, the end region 12 of the first or the second lugs 7, 8 is intended as contact tongues 13 of a plug connection 14 or as a soldered connection 15.

FIG. 4 shows the first wiper ring 4 with the first lugs 7, which are cast to make a rotor 16 of plastic 17, with the exception of the outer wiper ring surfaces 18 and the end regions 12 of the first lugs 7. The second wiper rings 5 with the second lugs 8 are received by a sleeve 19 of plastic 17. The sleeve 19 comprises two identical half-shells 20, 21 that become fixed to one another, and the sleeve 19 is received by an externally fixable housing 22. On the opposite end of the first lugs 7, the rotor 16 is provided with detent protrusions 23, which correspond with the sleeve 19 in such a way that an axial displacement of the rotor 16 is prevented; the rotor 16 is provided with a plug connection 14. The first and the second wiper rings 4, 5 are intended selectively for driving ohmic, inductive loads and video signals. For reducing friction upon rotation of the coupling 1, suitable plastic disks 31, 32 are provided. For cables, not shown here, the coupling 1 is provided with a tension relief 33, which comprises two half-shells that can be screwed on. The tension relief 33 is provided with a tab 29, for the sake of a firm connection, for instance at a swivel joint 24 of a tripod 25 (FIG. 14). For a firm connection to the housing 22, the tension relief 33 is provided with a groove connection 34.

FIG. 5 shows a plug connection 14 of FIG. 4 in an axial view.

FIG. 6 shows a section VI-VI of FIG. 4, showing the tension relief 33 for cables in more detail.

FIG. 7 shows a section VII-VII of FIG. 5, but without the tension relief 33.

FIG. 8 shows the rotor 16 with fragmentary sections in a plan view.

FIG. 9 shows a first half-shell 20 with second wiper rings 5 and second lugs 8, in a side view.

FIG. 10 shows a second half-shell 21 with second wiper rings 5 and second lugs 8, in a side view.

FIG. 11 shows the swivel coupling 1 in a side view.

FIG. 12 shows the soldered connection 15 in an axial view.

FIG. 13 shows the plug connection 14 in an axial view.

FIG. 14, as one example of an application, shows a side view of a tripod 25 with built-in swivel couplings 1, 1.1 for carrying and supplying an electrical appliance 40.

FIG. 15 shows the first swivel coupling 1 in a fragmentary sectional view.

FIG. 16 shows a second swivel coupling 1.1 in a fragmentary sectional view.

FIG. 17, in an enlarged view, shows the first swivel coupling 1 of FIG. 15, with a first and a second cable 36, 37, which are connected to the corresponding soldered connections 15 of the first and second wiper rings 4, 5.

FIG. 18, in an enlarged view, shows the second swivel coupling 1.1 of FIG. 16, with the second and a third cable 37, 38, which are connected to the corresponding soldered connections 15 of the first and second wiper rings 4, 5.

FIG. 19 shows a support 35 for a ceiling mounting, as a variant of the wall mounting of FIG. 14.

In FIGS. 20 through 22, three variants of swivel couplings 1 are shown, which differ essentially from one another in their outer geometry and the resultant fastening or mounting options. The coupling 1 can thus be adapted to various installation conditions.

Variant 1 (FIG. 20)

Axial fastening of plug coupling 27 and plug connection 28 by means of tabs 29, installed for instance in a tube with an inside diameter D1 of 24 mm.

Variant 2 (FIG. 21)

Axial fastening of the plug coupling 27 by means of tabs 29 and a radial fastening of the plug connection 28 by means of a threaded bore 30, for instance by installing the plug coupling 27 in a tube with an inside diameter D1 of 24 mm and installing the plug connection 28 in a tube with an inside diameter D2 of 31 mm.

Variant 3 (FIG. 22)

Radial fastening of the plug coupling 27 and the plug connection 28 by means of a threaded bore 30, for instance by installing the plug coupling 27 in a tube with an inside diameter D3 of 32 mm and installing the plug connection 28 in a tube with an inside diameter D2 of 31 mm.

The invention has the following advantages, in particular:
Solidly cast rotor 16, in which the wiper rings 4 and the outward-leading lugs 7 are made in one piece.
The wiper rings 4 are tapped with the aid of closed spring means 5 located on the outside, with specially shaped spring contacts 10, secured on one side to the spring ring 5, and are made in one piece with the second lug 8.
Minimized structural length, while maintaining all the installation thicknesses and air and creepage paths required by the VDE, for a power of 230V/16 A to be transmitted in the power portion and a power of 24V/2 A in the signal portion, including protective conductors.
Minimized diameter (24 mm), while maintaining all the installation thicknesses and air and creepage paths required by the VDE, for a power of 230V/16 A to be transmitted in the power portion and a power of 24V/2 A in the signal portion, including protective conductors.
Five current paths of equal rank, for instance for selective operation of ohmic and inductive loads, as well as video signals.
Capability of securing the coupling 1, 1.1 and connecting the protective conductor SL to the housing 22 by means of a radial screw fastening.
Integrated plug connection 28 for disconnecting the electrical connection.

List of Reference Numerals:
1, 1.1 Swivel coupling
2, 3 Wiper contact ring arrangement
4 First wiper ring
5 Second wiper ring
6 Direction
7 First lug
8 Second lug
9 Direction
10 Spring contact
11 Groove connection
12 End region
13 Contact tongue
14 Plug connection
15 Soldered connection
16 Rotor
17 Plastic
18 Wiper ring surface
19 Sleeve
20, 21 Half-shell
22 Housing
23 Detent protrusion
24 Swivel joint
25 Tripod
26 Notch
27 Plug coupling
28 Plug connection
29 Tab
30 Threaded bore
31 Plastic disk
32 Plastic disk
33 Tension relief
34 Groove connection
35 Support
36 First cable
37 Second cable
38 Third cable
39 Fourth cable
40 Electrical appliance
41 U-shaped recess
42 Weakening recess
43 Deformation
2L1, 2L2 Signal lines
SL Protective conductor
N, L Power line
D1, D2, D3 Diameter

1. An electrical swivel coupling with one inner and one outer wiper contact ring arrangement for transmitting electric currents, characterized in that
the inner wiper contact ring arrangement (2) is provided with a plurality of first wiper rings (4), which have first lugs (7) leading on one side outward in the direction (6) of the axis, and each first wiper ring (4) with a first lug (7) is of one-piece construction; that
the outer wiper contact ring arrangement (3) is provided with a plurality of second wiper rings (5), which have second lugs (8) leading on one side outward in an opposite direction (9) of the axis, and each second wiper ring (5) with a second lug (8) is of one-piece construction, and the second wiper rings (5) are provided with a plurality of spring contacts (10), which are formed by material recessing and deformation; and that
the spring contacts (10) of the second wiper rings (5) are coaxially in electrical contact with an outer wiper ring surface (18) of the first wiper rings (4).

2. The coupling of claim 1, characterized in that the first and second wiper rings (4, 5) with the first and second lugs (7, 8) have a T shape in a developed view.

3. The coupling of claim 1, characterized in that the first and second wiper rings (4, 5) are joined together in a ring by a material-engagement groove connection (11).

4. The coupling of claim 1, characterized in that selectively the end region (12) of the first or second lugs (7, 8) is provided as contact tongues (13) of a plug connection (14) or as a soldered connection (15).

5. The coupling of claim 1, characterized in that the first wiper rings (4) with the first lugs (7) are cast to form a rotor (16) of plastic (17), with the exception of the outer wiper ring surfaces (18) and the end regions (12) of the first lugs (7).

6. The coupling of claim 1, characterized in that the second wiper rings (5) with the second lugs (8) are received by a sleeve (19) of plastic (17).

7. The coupling of claim 6, characterized in that the sleeve (19) comprises two identical half-shells (20, 21) that become fixed to one another.

8. The coupling of claim 6, characterized in that the sleeve (19) is received by a housing (22) that can be fixed on the outside.

9. The coupling of claims 5 and 6, characterized in that the rotor (16) on the opposite end of the first lugs (7) is provided with detent protrusions (23), which correspond with the sleeve (19) in such a way that an axial displacement of the rotor (16) is prevented.

10. The coupling of claim 1, characterized in that the rotor (16) is provided with a plug connection (14).

11. The coupling of claim 1, characterized in that the first and the second wiper rings (4, 5) are selectively provided for driving ohmic, inductive loads and video signals.

12. The coupling of claim 1, characterized in that the coupling (1) is intended for a swivel joint (24) of a tripod (25).
